(19) United States
(12) Patent Application Publication
(10) Pub. No.: US 2010/0272331 A1
(43) Pub. Date: Oct. 28, 2010

(54) METHOD FOR ASSESSING MEASUREMENT QUALITY AND DEVICE FOR IMAGING THE INTERIOR OF MEDIA

(75) Inventors: Bernhard Johannes Brendel, Hamburg (DE); Tim Nielsen, Hamburg (DE); Levinus Pieter Bakker, Shanghai (CN); Henricus Wilhelm Peter Van Der Heijden, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/747,177

(22) PCT Filed: Dec. 10, 2008
(86) PCT No.: PCT/IB08/55187

§ 371 Date: Jun. 10, 2010

(30) Foreign Application Priority Data
Dec. 17, 2007 (EP) 07123333.2
May 6, 2008 (EP) 08155696.1

(51) Int. Cl. G06T 7/00

(52) U.S. Cl. 382/128

(57) ABSTRACT

A method for assessing measurement quality in acquisition of an image of the interior of a medium (1) is provided. The method comprises the steps: subsequently irradiating the medium (1) with light from a plurality of different source positions (s) and, for each source position, detecting light emanating from the medium in a plurality of different detection positions (d) for acquisition of an image of the interior of the medium (1). The method further comprises the step: providing information about whether the measurement quality is deteriorated by exploiting signal symmetry under reversal of the light path.

### FIELD OF INVENTION

The present invention relates to a method for assessing measurement quality in acquisition of an image of the interior of a medium and to a device for imaging the interior of media.

### BACKGROUND OF THE INVENTION

In the context of the present application, the term turbid medium is to be understood to mean a substance consisting of a material having a high light scattering coefficient, such as for example intralipid solution or biological tissue. Further, light is to be understood to mean electromagnetic radiation, in particular electromagnetic radiation having a wavelength in the range from 180 nm to 1400 nm. The term “optical properties” covers the reduced scattering coefficient μ′ₛ and the absorption coefficient μₐ. Furthermore, “matching optical properties” is to be understood as having a similar reduced scattering coefficient μ′ₛ and a similar absorption coefficient μₐ.

A method for imaging the interior of turbid media, e.g. for breast cancer screening, which has become popular in recent years is imaging by use of light, in particular using light in the near infrared (NIR). Such methods are implemented in mammography devices and devices for examining other parts of human or animal bodies. A prominent example for such a method for imaging the interior of a turbid medium by means of light is Diffuse Optical Tomography (DOT). For example, such a DOT device for imaging the interior of a turbid medium uses a light source to irradiate the turbid medium and photodetectors for measuring a part of the light transported through the turbid medium, i.e. its intensity. A control unit is provided for controlling the scanning process. A processing unit is provided for reconstructing an image of the interior of the turbid medium on the basis of the measured intensities. Some of the known devices are particularly adapted for examining female breasts. In order to allow the examination of the turbid medium, the device is provided with a receiving portion enclosing a receiving volume and arranged to receive the turbid medium. Light from the light source is coupled into the receiving volume and into the turbid medium. The light is chosen such that it is capable of propagating through the turbid medium. For imaging an interior of a female breast, light in the NIR (near infrared) is typically used. Scattered light emanating from the turbid medium as a result of coupling light into the receiving volume is coupled out of the receiving volume. Light coupled out of the receiving volume is used to reconstruct an image of an interior of the turbid medium. The light used for examining the turbid medium has to be transmitted from the light source to the turbid medium and from the turbid medium to the photodetectors. Due to different sizes of the turbid media to be examined, the size of the receiving portion may not perfectly match the size of the turbid medium, i.e. a space remains between the boundary of the receiving volume and the turbid medium. The part of the turbid medium under investigation is surrounded by a scattering medium (coupling medium) filling the space in the receiving volume. The scattering medium is chosen such that the optical parameters of the scattering medium, such as the absorption and scattering coefficients, are similar to the corresponding optical parameters of the turbid medium. The light source subsequently irradiates the turbid medium from different directions and the photodetectors measure a part of the light transmitted through the turbid medium. A plurality of such measurements are performed with the light directed to the turbid medium from different directions and, based on the results of the measurements, i.e. the obtained data set, the processing unit reconstructs the image of the examined turbid medium.

In methods for imaging the interior of media, the acquisition of one data set may take several minutes. During this time of data acquisition, e.g. when the medium under examination is a female breast, the medium may move which can substantially deteriorate the measurement quality and thus the quality of the reconstructed image. In such cases in which the medium is moved during the measurement, the acquired measurement data becomes inconsistent and the measurement should be repeated. However, in current systems for imaging the interior of media, in particular in devices for diffuse optical tomography, the fact that the medium has moved during the measurement will only become clear when the measurement data are analyzed and an image of the interior of the medium is reconstructed based on the measurement data. At this point in time, for example in imaging of female breasts, the medium will in most cases no longer be accommodated in a receiving volume of the device for imaging the interior of media. A patient will even have gone home and repeating the measurement requires a large effort and generates additional costs.

Similarly, known devices for imaging the interior of media, in particular turbid media, comprise a large number of source positions for irradiating the medium under examination and a large number of detection positions for detecting light emanating from the medium. For example, a plurality of detectors may be provided and a plurality of light guides such as for instance light guiding fibers may be provided. For a measurement of a patient, it is essential that the device for imaging the interior of media operates correctly. However, due to the structure comprising the plurality of source positions and the plurality of detection positions, the measurement quality can be deteriorated by malfunction of source positions or detection positions. Such malfunction can for instance be caused by damaged detectors or by damaged light guides. Thus, a there is a need for a procedure to monitor the performance and the state of the device for imaging the interior of media.

### SUMMARY OF THE INVENTION

It is an object of the present invention to provide a method for assessing measurement quality in acquisition of an image of the interior of the medium and a device for imaging the interior of media with which it can be determined immediately after or during a measurement if the measurement quality is deteriorated due to a medium under examination having moved during the measurement or due to malfunction of a source position or detection position.

The object is solved by a method for assessing measurement quality in acquisition of an image of the interior of a medium according to claim 1. The method comprises the steps: subsequently irradiating the medium with light from a plurality of different source positions and, for each source position, detecting light emanating from the medium in a plurality of different detection positions for acquisition of an image of the interior of the medium. The method further comprises the step: providing information about whether the measurement quality is deteriorated by exploiting signal symmetry under reversal of the light path. Since signal symmetry with respect to reversal of the light path is used for providing information about whether the measurement quality is deteriorated a fast and efficient method for determining the quality of the measurement is provided. Thus, it can be determined immediately after or during the measurement whether the medium has moved or not and, in the case that a motion has occurred, a new measurement can be started immediately after the first measurement. As a consequence, costs and efforts can be saved. The information may be provided as a result that motion has occurred or as information allowing an operator to decide whether motion has occurred or not. Further, it can be detected and analyzed in a convenient way if the source positions and the detection positions operate correctly.

Preferably, during image acquisition, measurement values are acquired for a plurality of pairs of source position and detection position. For determining deterioration of measurement quality, a measurement value for a first pair of source position and detection position and a measurement value for at least one other pair of source position and detection position are compared. The arrangement of source position and detection position for the at least one other pair is substantially reversed with respect to the first pair. In this case, measurement deterioration caused by motion or malfunction of a source position or detector position can be detected by comparing the measurement values for both pairs.

According to an aspect, for a measurement value corresponding to a first pair of source position and detection position, a plurality of measurement values for other pairs of source position and detection position are acquired. A value corresponding to the reversed arrangement of source position and detection position with respect to the first pair is calculated from this plurality of measurement values. The arrangement of source position and detection position for these other pairs is adjacent to the reversed arrangement of the first pair. In this case, the arrangement of source and detection positions can be used for determining deterioration of measurement quality and signal symmetry with respect to a reversal of the light path can be reliably exploited even if direct interchange of source position and detection position is not possible.

According to a further aspect, a virtual measurement value for a first pair of source position and detection position is calculated from a plurality of measurement values for other pairs of source position and detection position, the arrangement of source position and detection position of the other pairs being adjacent to that of the first pair. A virtual measurement value corresponding to the reversed arrangement of source position and detection position with respect to the first pair is calculated from a plurality of measurement values for different pairs of source position and detection position, the arrangement of source position and detection position of the different pairs being adjacent to the reversed arrangement of source position and detection position of the first pair. In this case, both, the value for the first pair as well as the value for the reversed arrangement, are calculated from values corresponding to adjacent pairs. Thus, even in cases in which direct interchange of source position and detection position is not possible, symmetry between the compared values is ensured.

If the light used for irradiating is in the wavelength range between 180 nm and 1400 nm, the method can be applied in devices for diffuse optical tomography in which the actual reconstruction of an image of the interior of the medium takes some time. In these devices it is particularly important to quickly obtain information about deterioration of measurement quality such that a measurement can be repeated, if necessary.

Preferably, the information is provided as a graphical representation. In this case, an operator can immediately decide based on the representation whether deterioration of measurement quality has occurred or not and which measures are appropriate.

According to an aspect, deterioration of measurement quality is automatically detected. Thus, the deterioration of measurement quality can be directly notified to an operator and no further analysis by the operator is required.

According to one aspect, information is provided about whether motion of the medium (1) has occurred during image acquisition by exploiting the signal symmetry. According to another aspect, information is provided about whether at least one source position or detection position malfunctions by exploiting the signal symmetry.

The object is further solved by a device for imaging the interior of media according to claim 9. The device comprises a receiving volume for receiving a medium to be examined; at least one light source arranged to subsequently irradiate the receiving volume with light from a plurality of different source positions; and at least one detector arranged to detect, for image acquisition, light emanating from the receiving volume in a plurality of different detection positions for each source position. The device further comprises a processing unit adapted to provide information about whether the measurement quality is deteriorated by exploiting signal symmetry under reversal of the light path. Thus, the quality of the measurement can be checked fast and efficiently. Further, motion of a medium under examination can be determined immediately after or during the measurement. If required, a new measurement can be started immediately after the first measurement. Information can be provided e.g. in form of a result that motion has occurred or in form of information allowing an operator to decide whether motion has occurred or not. Further, bad source positions and or detection positions can be reliably identified.

Preferably, the plurality of different source positions and the plurality of different detection positions are distributed at a boundary of the receiving volume. In this case, the sites of source and detection positions are clearly predetermined and determination of deterioration of the measurement quality can be easily and reliably performed for each measurement.

In the case that the source positions and detection positions are alternately distributed surrounding the receiving volume, source and detection positions realizing a light path substantially reversed to the light path of a specific pair of source and detection positions is provided for a large number of combinations of source positions and detection positions.

Preferably, the boundary of the receiving volume is formed by a receiving portion adapted to be filled with a scattering medium for filling a space between the receiving portion and the medium. In this case, satisfactory coupling between the source positions and the medium and between the medium and the detection positions can be provided by using an optically scattering medium.

According to an aspect, the receiving volume is formed by a pair of plates for holding the medium in a compressed condition during data acquisition. In this case, deterioration of the measurement quality can be reliably detected in systems requiring compression of media for data acquisition.

According to aspects, the processing unit is adapted to provide information about whether motion of the medium has occurred during image acquisition by exploiting the signal symmetry or the processing unit is adapted to provide information about whether at least one source position or detection position malfunctions by exploiting the signal symmetry.

Preferably, the device is a medical image acquisition device.

### BRIEF DESCRIPTION OF THE DRAWINGS

Further features and advantages of the present invention will arise from the detailed description of embodiments with reference to the enclosed drawings.

FIG. 1 schematically shows a receiving volume of a device for imaging the interior of media with a turbid medium placed therein.

FIG. 2 schematically shows the arrangement of source positions and detection positions in the device of FIG. 1.

FIG. 3 illustrates the interpolation of virtual reconstruction input values according to an embodiment.

FIG. 4 is a further illustration for explaining the interpolation of virtual reconstruction input values according to the embodiment.

FIG. 5 is a graphical representation provided according to the embodiment in case of a slow movement of the medium during a measurement.

FIG. 6 is a graphical representation in case of a sudden movement of the medium during a measurement.

### DETAILED DESCRIPTION OF EMBODIMENTS

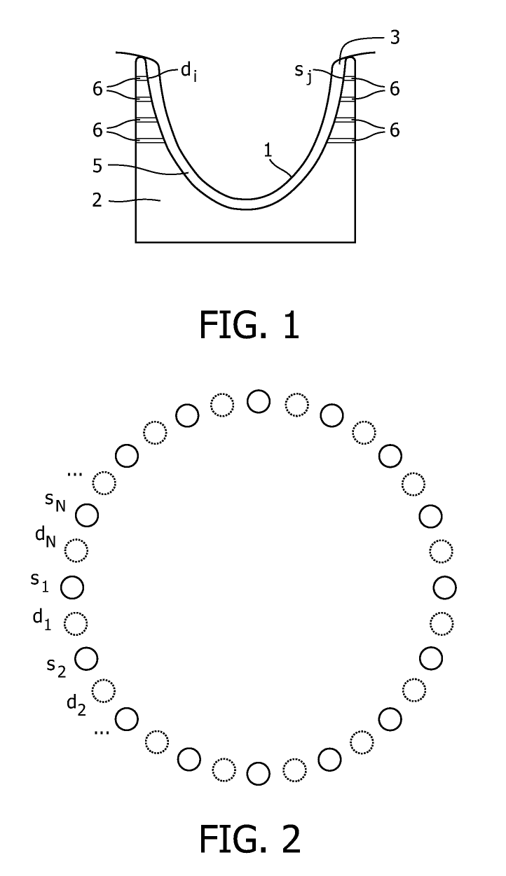

An embodiment of the present invention will now be described with reference to FIGS. 1 to 4. The device for imaging the interior of media according to the embodiment is a device for diffuse optical tomography (DOT). In particular, the device is adapted for examination of turbid media such as female breasts. The overall construction of such a device is known in the art. The device comprises a bed (not shown) on which the person under examination is lying in a prone position. An opening is formed in the bed below which a receiving portion 2 extends. The receiving portion 2 is shown in FIG. 1.

In the device shown in FIG. 1, the turbid medium 1 to be examined is a female human breast. The receiving portion 2 encloses a receiving volume (measuring volume) adapted to receive the turbid medium 1, as schematically indicated in FIG. 1. The receiving portion 2 has a cup-like shape and is provided with an opening 3. As can be seen in FIG. 1, the turbid medium 1 to be examined, i.e. the breast, is placed in the receiving portion 2 such that it freely hangs in the receiving volume from the side of the opening 3. The receiving portion 2 serves to position and stabilize the turbid medium 1 which is examined.

The inner surface of the receiving portion 2 facing the turbid medium 3 is provided with a plurality of ends of light guides 6 formed by optically guiding fibers connecting to a light source and to a plurality of detectors (not shown). Preferably, the light source is a laser emitting light in the wavelength range between 180 nm and 1400 nm. The ends of the light guides 6 are distributed on the inner surface of the receiving portion 2. The device is adapted such that light from the light source can be directed to the turbid medium 1 from a plurality of different directions and light emanating from the turbid medium 1 can be detected by a plurality of detectors the corresponding light guides 6 of which are distributed on the inner surface of the receiving portion 2. The ends of the light guides 6 at the inner surface of the receiving portion 2 form a plurality of source positions sⱼ (with: 1≦j≦M; M being the number of source positions) and a plurality of detection positions dᵢ (with 1≦i≦L; L being the number of detection positions). In the embodiment the overall number of source positions sⱼ is equal to the overall number of detection positions dᵢ (i.e. M=L), however, the invention is not limited to an equal number. For example, in the device according to the embodiment, 256 different source positions are provided (M=256) and 256 detector positions (L=256), i.e. respective ends of light guides 6 are provided on the inner surface of the receiving portion 2. The light from the light source is subsequently directed to the turbid medium 1 from the 256 source positions and, for each source position, the light emanating from the turbid medium 1 is detected in the 256 detection positions. However, the invention is not limited to these specific numbers.

As can be seen from FIGS. 1 and 2, in the embodiment the source positions s and detection positions d are distributed on rings extending around the vertical axis of the receiving portion 2. FIG. 2 schematically illustrates the arrangement of source positions s and detection positions d in one ring, e.g. the uppermost ring of source and detector positions shown in FIG. 1. As can be seen in FIG. 2, in the embodiment, N source positions s (sᵢ, s₂, . . . s_{N}) and N detection positions d (d₁, d₂, . . . d_{N}) are alternately distributed on the ring, the respective positions being numbered from 1 to N. Although an alternating arrangement of source positions s and detection positions d is provided according to the embodiment, the invention is not limited to this realization and other arrangements are possible as well. However, it will be seen that the alternating arrangement provides advantages.

The device comprises a processing unit (not shown) for controlling the acquisition of images by diffuse optical tomography. The processing unit reconstructs an image of the interior of the turbid medium 1 based on the signals from the detectors. For reconstruction, the signals sampled during a scan in which the light is directed to the turbid medium 1 from different directions are used. For reasons of simplicity, these elements of the device for imaging the interior of a turbid medium which are known in the art will not be described again.

The receiving portion 2 is further structured such that a space remains between the inner surface of the receiving portion 2 and the turbid medium 1. For examination, this space is filled with an optically scattering medium 5. The optically scattering medium 5 is selected to provide appropriate optical coupling between the turbid medium 1 to be imaged and the source positions s and the detection positions d distributed on the inner surface. For this purpose, the optically scattering medium 5 is provided with optical properties similar to the optical properties of the turbid medium 1 to be examined.

So far, it has been described how the device for imaging the interior of turbid media operates. However, as mentioned above, if the turbid medium 1 is moved during the measurement, i.e. during data acquisition, the data become inconsistent and the measurement should be repeated. It will now be described how a movement of the turbid medium 1 during the measurement is detected according to the embodiment and how the result of such detection is notified to an operator.

The method for motion detection is based on the principle of source-detector symmetry. The source-detector symmetry is a valid principle for optical measurements and means the following: If a source and a detector are placed at certain positions in space, a certain signal can be measured with the detector when the source emits light. The same signal is measured, if the position of source and detector are interchanged. For the arrangement of the present embodiment this means: the same signal is expected if the source position and the detection position are interchanged. This principle is also known as signal symmetry under reversal of the light path; by interchanging the source position and the detection position, the light path is reversed and the same signal is expected. This symmetry principle holds for electromagnetic radiation as long as the tensors for the material properties in the relevant Maxwell equations are symmetric. In only a few and very special cases which are not relevant for the present subject-matter the reciprocity principle does not hold.

However, one main reason for consecutive measurements not to satisfy the signal symmetry under reversal of the light path is a change of the optical properties of the medium arranged between source position and detection position. For, example such change in optical properties can be due to a movement of objects located in the light path, e.g. a movement of the turbid medium 1 under examination in the embodiment. Thus, it is disclosed to use the analysis of signal symmetry under reversal of the light path as a tool for detecting whether a turbid medium 1 under examination has moved during a measurement or not.

A straight-forward possibility would be to perform one measurement with a certain source position and a certain detection position and a further measurement with the former detection position used as source position and the former source position used as detection position in order to analyze whether the symmetry is provided. If the arrangements of source positions and detection positions in the device for imaging the interior of turbid media allow such measurements, such measurements can be performed and the attained results can be used for the further analysis described below.

However, in the device for imaging the interior of turbid media according to the embodiment, the source positions s can only be used as source positions and not as detection positions. Similarly, the detection positions d can only be used as detection positions and not as source positions. This is due to the connection of the source positions to the light source and the connection of the detection positions to the plurality of detectors which is realized by means of light guiding fibers and a fiber switch for the light guiding fibers connecting to the light source. Thus, in the device for imaging the interior of turbid media according to the embodiment, the source-detector symmetry cannot be exploited directly. To circumvent this problem, virtual measurements that fulfill the prerequisite for source-detector symmetry are interpolated according to the embodiment. The calculation of these virtual measurements will be explained in the following with reference to FIGS. 1 to 4. In the following explanation, the calculation will be explained with respect to one ring of source positions and detection positions for reasons of simplicity. However, a skilled person will understand that the calculation is not limited to a specific ring.

For reconstructing an image of the interior of the turbid medium 1 from the measurement results, reconstruction input values m(sᵢ, dⱼ) are used for a specific combination of source position sᵢ and detection position dⱼ. Such reconstruction input values are calculated for all combinations of source positions s and detection positions d. The reconstruction input values are calculated from two measurements, a reference measurement (for example a measurement in which the receiving volume is completely filled with the scattering medium) resulting in measured intensities Φ_{ref} and an actual measurement with the turbid medium 1 placed in the receiving portion 2 resulting in measured intensities Φ_{act}. The reconstruction input values are calculated according to the equation:

$$m ( {s}_{i} , {d}_{j} ) = - ln \frac{{Φ}_{act} ( {s}_{i} , {d}_{j} )}{{Φ}_{ref} ( {s}_{i} , {d}_{j} )}$$

Since the source-detector symmetry property holds for both measurements, it also holds for the reconstruction input values m.

Due to the specific arrangement of source positions s and detection positions d in the device according to the embodiment, available reconstruction input values are m(sᵢ, dⱼ) and the corresponding values for source position and detection position exactly interchanged are not available. Thus, no available pair of reconstruction input values fulfills the source-detector symmetry condition m(a, b)=m(b, a). However, there are pairs of reconstruction input values thinkable which would fulfill the source-detector symmetry, if they were available, namely:

m(sᵢ,sⱼ)=m(sⱼ,sᵢ)

m(dᵢ,dⱼ)=m(dⱼ,dᵢ).

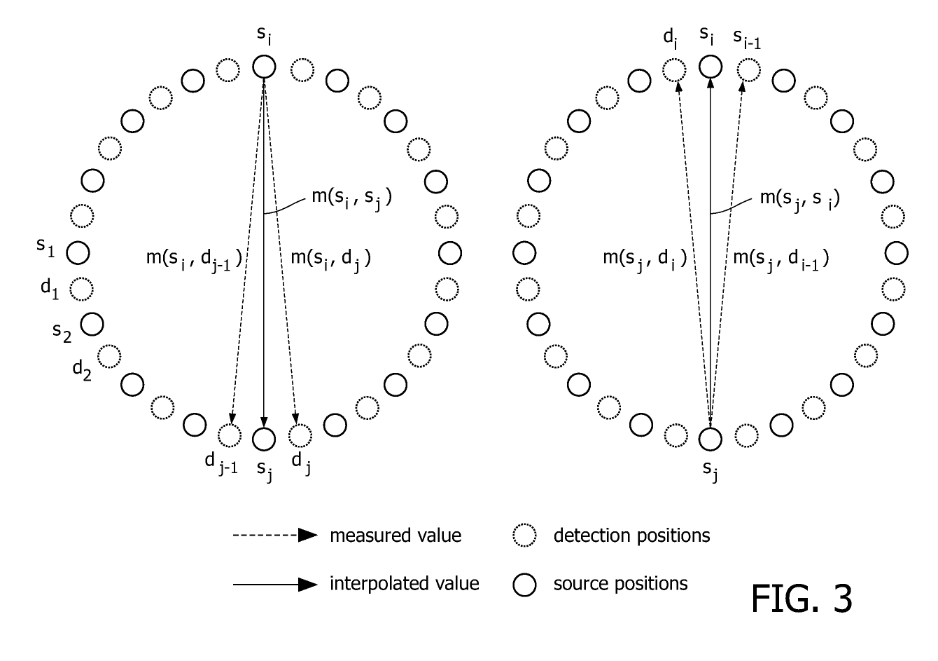

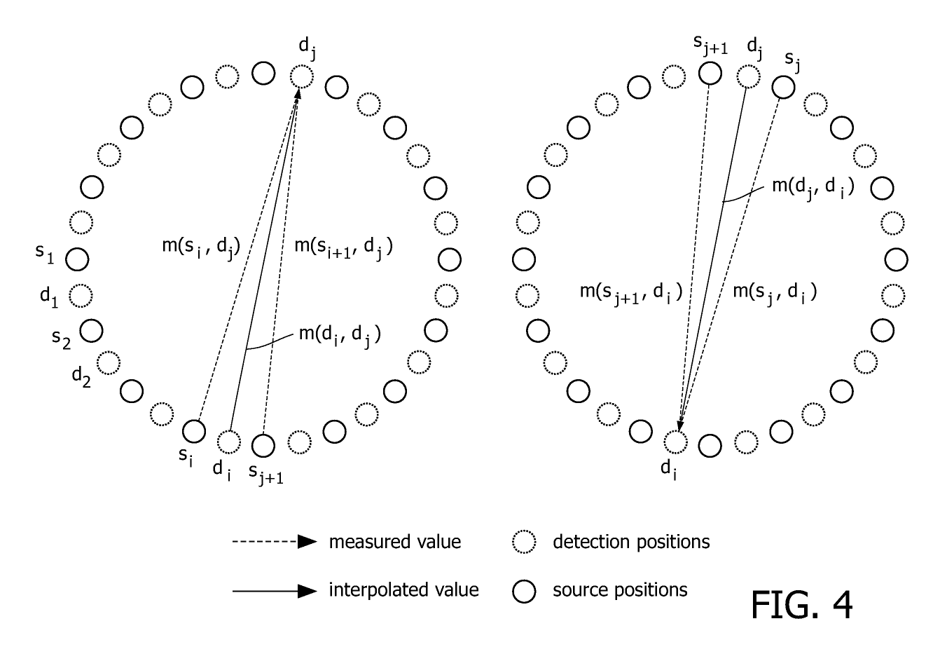

It will now be described with reference to FIGS. 3 and 4 how these (virtual) values are calculated by interpolation. FIG. 3 illustrates the calculation of m(sᵢ, sⱼ) and m(sⱼ, sᵢ), FIG. 4 illustrates the calculation of m(dᵢ, dⱼ) and m(dⱼ, dᵢ).

As can be seen from FIG. 3, the (virtual) reconstruction input value m(sᵢ, sⱼ) is calculated based on the measured reconstruction input values m(sᵢ, dⱼ) and m(sᵢ, dⱼ₋₁). These measured reconstruction input values are acquired for the source position sᵢ of the (virtual) reconstruction input value and two detection positions dᵢ and dⱼ₋₁ located directly adjacent to the source position sᵢ forming the virtual detection position. According to the embodiment, m(sᵢ, sⱼ) is calculated by interpolation based on the equation: m(sᵢ, sⱼ)=0.5 [m(sᵢ, dⱼ)+m(sᵢ, dⱼ₋₁)]. Similarly, the (virtual) reconstruction input value m(sⱼ, sᵢ) is calculated by interpolation from the measured reconstruction input values m(sⱼ, dᵢ) and m(sᵢ, dⱼ₋₁) by interpolation according to m(sⱼ, sᵢ)=0.5 [m(sⱼ, dᵢ)+m(sⱼ, dᵢ₋₁)].

Thus, the (virtual) reconstruction input value (m(sᵢ, sⱼ) and m(sⱼ, sᵢ), respectively) which is not actually measured (e.g. because it cannot be measured) is calculated based on two measured reconstruction input values. For each of these measured reconstruction input values, the respective source position s and detection position d are located close to the source and detector positions for which the (virtual) reconstruction input value is calculated.

As can be seen in FIG. 4, the (virtual) reconstruction input values m(dᵢ, dⱼ) and m(dⱼ, dᵢ) are calculated in a similar way based on the measured reconstruction input values m(sᵢ, dⱼ), m(sᵢ₊₁, dⱼ) and m(sⱼ, dᵢ), m(sⱼ₊₁, dᵢ). They are interpolated according to m(dᵢ, dⱼ)=0.5 [m(sᵢ, dⱼ)+m(sᵢ₊₁, dⱼ)] and m(dⱼ, dᵢ)=0.5 [m(sⱼ, dᵢ)+m(sⱼ₊₁, dᵢ)].

According to the embodiment, such virtual reconstruction input values m(d, d), m(s, s) are calculated for all pairs of source positions s and detection positions d. Thus, after such calculation, the pairs of reconstruction input values m(sᵢ, sⱼ), m(sⱼ, sᵢ) and m(dᵢ, dⱼ), m(dᵢ, dᵢ) for which the source-detector symmetry should hold are provided.

Although it has been described that virtual reconstruction input values are calculated by interpolation from two adjacent measured positions, the invention is not limited thereto and interpolation from more distinct adjacent measured positions is possible depending on the arrangement of source positions and detection positions. I.e. more than two light paths distributed around the reversed light path can be used and the average can be calculated from these.

Further, if the construction of source positions and detection positions in a device for imaging the interior of turbid media allows direct interchange of source and detection positions, such pairs can be directly taken from the measurements without interpolation step.

It will now be described how the symmetry under reversal of the light path is used for analyzing whether motion of a turbid medium 1 has occurred. Assuming that there are N detection positions and N source positions distributed about the receiving portion 2, for each pair of indices i and j (i=1, . . . N and j=1, . . . N) two pairs of virtual reconstruction input values can now be compared. For example, this comparison can be realized by analyzing the differences [m(sⱼ, sᵢ)−m(sᵢ, sⱼ)] and [m(dⱼ, dᵢ)−m(dᵢ, dⱼ)] which should be zero, if the source-detector symmetry is fulfilled. According to the embodiment, the result of this comparison is visualized in a graphical representation in a coordinate system. For example, the coordinate system has two perpendicular axes corresponding to the two indices i and j, and a gray scale value in each point corresponds to the values of the differences. However, other suitable graphical representations are possible as well.

According to an example, in the upper right part of the graphical representation the differences m(dⱼ, dᵢ)−m(dᵢ, dⱼ) are represented, and in the lower left part the differences m(sⱼ, sᵢ)−m(sᵢ, sⱼ) are represented. This represents all possible differences, since the differences are symmetric: m(sⱼ, sᵢ)−m(sᵢ, sⱼ)=−[m(sᵢ, sⱼ)−m(sⱼ, sᵢ)]. The differences as represented in the plot will be designated as I_{x,y} with the first index being the row index and the second index being the column index. This kind of visualization is called asymmetry plot.

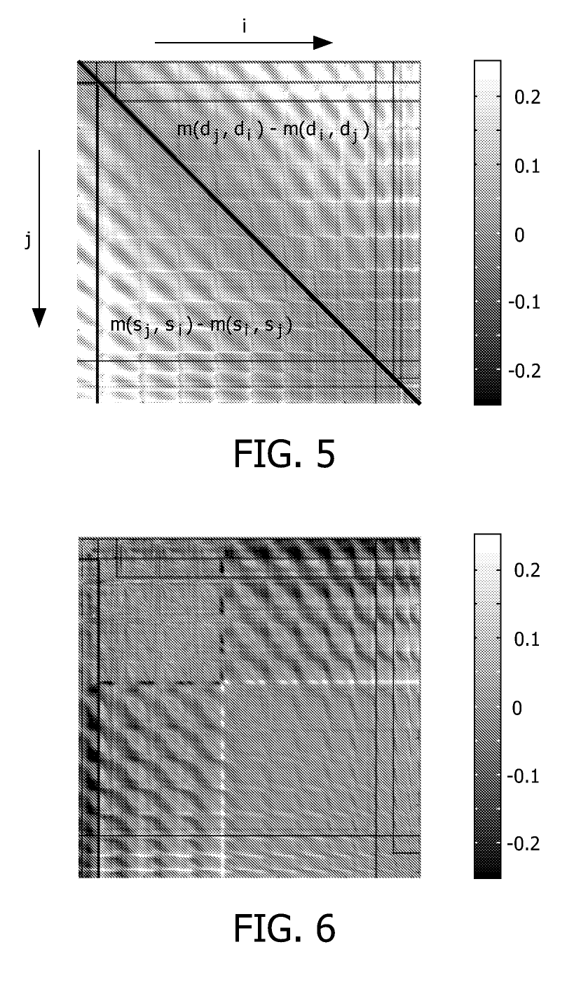

FIG. 5 shows such an asymmetry plot for a slow movement of the turbid medium 1 under examination during measurement data acquisition. As can be seen referring to the gray scale bar in FIG. 5, the values in the asymmetry plot are not zero. Possible reasons for this are interpolation errors, noise, or movement of the turbid medium 1. According to the embodiment, the order of the source indices corresponds to the order of the acquisition, i.e. source sᵢ is the first for which data is acquired, and source s_{N} is the last. Thus, the time difference of the measured data compared to the imaged differences in the plot increases from the diagonal (top left to bottom right) to the top right and bottom left corners. As a consequence, the gradient in the asymmetry plot from values of approximately zero near the diagonal to positive values in the corners is neither due to interpolation errors, nor due to noise, but due to the slow movement of the turbid medium 1 in the receiving portion 2 during the measurement. This has been confirmed by phantom experiments in which identical patterns occur for slow movements of objects in the receiving portion 2.

FIG. 6 shows an asymmetry plot for a case in which a sudden movement of the turbid medium has occurred during examination. In this case, the visualized differences are approximately zero in only two quadrants of the image. This is due to the fact that the source-detector symmetry holds before the movement (corresponding to the upper left quadrant) and after the movement (corresponding to the lower right quadrant). It does not hold if one measurement is done before the movement and the other after the movement of the turbid medium 1 as in case of the other two quadrants in FIG. 6. The occurrence of this pattern has also been confirmed by phantom experiments.

Thus, movement of the turbid medium 1 during examination leads to easily detectable patterns in the data asymmetry plot. This holds for slow and for sudden movements. The asymmetry plot can be calculated very fast based on raw measurement data. Thus, movements of the turbid medium 1 during the measurement can be analyzed very fast, e.g. immediately after or during the measurement.

The concept according to the embodiment is based on the signal symmetry under reversal of the light path. It uses the fact that, if the turbid medium 1 moves during data acquisition, the symmetry is broken. The difference between respective signals is plotted in a diagram from which the occurrence of motion can be determined.

The asymmetry plot has been described above as a specific way of visualization. However, other ways of visualization are also possible.

Motion of the turbid medium 1 under examination can be detected for any time point of the data acquisition without redundant measurements immediately after or even during the scan. As a result, an operator of the device for imaging the interior of turbid media can decide whether the measurement data is deteriorated by motion of the turbid medium 1 while the turbid medium 1 is still placed in the receiving portion 2. In the case that deterioration has occurred, the measurement can be partly or completely be repeated. The method is not limited to the geometry of the receiving portion 2 described with respect to the embodiment but can also be adapted to other systems fulfilling certain design constraints as a skilled person will understand.

It has been described above that a graphical representation is provided to an operator which can then decide based on the graphical representation whether a motion of the turbid medium 1 has occurred and decide whether the measurement is repeated or not. However, as an alternative, the decision can be automated using appropriate algorithms, e.g. image processing algorithms.

Since the method provides detailed information on which data of the measurement set of data are affected by motion and should be measured again, it can be used to plan the repeat measurement such that only the data acquired before the motion of the turbid medium 1 has occurred is acquired again.

Above it has been described with respect to the embodiment that the signal symmetry under reversal of the light path is used for detecting motion of a medium under examination as a possible source for measurement deterioration. However, the invention is not restricted to motion detection but the method can for instance also be used for detecting malfunction of a source position or detection position as a source for measurement deterioration. This will be described in the following.

In the case of a malfunctioning source position or detection position, the principle of source-detector symmetry will be violated. Thus, the calculated values for a bad source or detection position which should be zero (as described above) will substantially differ from zero. Thus, the alternatives describe above with respect to motion detection can also be used for detecting bad source positions or detection positions.

For the asymmetry plot described above, due to the arrangement of the indices corresponding to source positions and detection positions on the axes of the asymmetry plot, in the case of malfunction of one or more source positions or of one or more detection positions, a horizontal and a vertical line will show in the asymmetry plot in the position corresponding to the bad source position and/or detection position. Thus, bad source and/or detection positions can be identified by analyzing the asymmetry plot for horizontal and vertical lines and, in case of such lines, relating the position of the lines to one or more of the source and/or detection positions.

Thus, the presence of bad source positions or bad detection positions, i.e. malfunctioning source and/or detection positions, can be conveniently detected by exploiting the source-detector symmetry in the manner described above. This means, deterioration of the measurement can be detected and additionally the cause for the deterioration can be reliably identified.

Further, an automatic detection scheme for identifying bad source and/or detection positions can be used. For the detection of bad detection positions or bad source positions, according to one example the following equation is used as a criterion for a bad source or detector (with I_{x,y} being the matrix elements of the asymmetry plot):

$${T}_{i} = \sqrt{{\sum }_{j} {( \frac{{I}_{j , i - 1}}{{I}_{j , i}} - 1 )}^{2}} - \sqrt{{\sum }_{j} {( \frac{{I}_{i - 1 , j}}{{I}_{i , j}} - 1 )}^{2}} .$$

The ratio between two horizontally adjacent matrix elements minus 1 is calculated and squared (for all rows) and the summation over all rows is performed; and the square root of the summation is calculated (first term on the right hand side in the equation above). Further, the ratio between two vertically adjacent matrix elements minus 1 is calculated and squared (for all columns) and the summation over all columns is performed; and the square root of the summation is calculated (second term on the right hand side in the equation above). This calculation is performed such that, in the second term the row indices i, i−1 correspond to the column indices i, i−1 in the first term. The difference between the first term and the second term is calculated as an indicator Tᵢ. The source position/detection position with the highest index number is neglected in this calculation. Based on the given symmetry, it can be defined as a criterion for judging that a bad source position or detection position is present if the indicator Tᵢ exceeds a certain threshold value ξ(Tᵢ>ξ). It has been found that in practical implementation a suitable threshold value ξ is typically in the order of 0.5 to 1. It should be noted that the above described calculation using the threshold value always results in two adjacent source positions or detection positions for which the criterion holds.

As a result, an automatic detection scheme providing information about the quality of the measurement is provided. The detection scheme detects whether a source position or a detection position works properly. Thus, according to the example, a relatively standard algorithm for detection of sharp vertical or horizontal features is used for detection of bad source positions or detection positions. The invention is not restricted to the algorithm described above but other algorithms for detection of sharp horizontal or vertical contrasts in a matrix can also be used. Thus, different methods can be used for detection of bad source and/or detection positions.

In the above example, the fact is used that the asymmetry plot is symmetrical for a consistent data set, i.e. a data set for which source-detector symmetry holds. Any non-symmetry is a sign of inconsistency as for instance a bad source position or detection position.

Of course, the above described method may also be applied in cases in which a contrast agent such as e.g. a fluorescent contrast agent has been injected into the turbid medium before the measurement and light emanating from the contrast agent is detected.

Although the method has been described for diffuse optical imaging, the invention is not limited thereto and can in principle also be applied in non-optical imaging modalities such as x-ray or CT. In this case, the medium is not turbid but only weakly scattering. Further, the method can be applied in PET (positron emission tomography) or SPECT (single photon emission computed tomography) applications.

Although it has been described that a receiving portion having a cup-like shape is provided which surrounds the receiving volume, the disclosure is not limited to this. The receiving volume may also comprise a different shape. For example, compression plates may be provided between which a medium to be examined is held in a (slightly) compressed condition during the measurements, the compression plates enclosing the receiving volume. According to one possible alternative, these compression plates are formed by two parallel plates the distance between which can be changed for compressing the received medium. Other shapes and realizations are also possible.

1. Method for assessing measurement quality in acquisition of an image of the interior of a medium (1);
the method comprising the steps:
subsequently irradiating the medium (1) with light from a plurality of different source positions (s) and, for each source position, detecting light emanating from the medium in a plurality of different detection positions (d) for acquisition of an image of the interior of the medium (1); and
providing information about whether the measurement quality is deteriorated by exploiting signal symmetry under reversal of the light path.

2. Method according to claim 1, wherein, during image acquisition, measurement values are acquired for a plurality of pairs of source position (s) and detection position (d) and, for determining deterioration of measurement quality, a measurement value for a first pair of source position and detection position and a measurement value for at least one other pair of source position and detection position, with the arrangement of source position and detection position substantially reversed with respect to the first pair, are compared.

3. Method according to claim 1, wherein, for a measurement value corresponding to a first pair of source position (s) and detection position (d), a plurality of measurement values for other pairs of source position and detection position are acquired and a value corresponding to the reversed arrangement of source position (s) and detection position (d) with respect to the first pair is calculated from this plurality of measurement values; the arrangement of source position and detection position for these other pairs being adjacent to the reversed arrangement of the first pair.

4. Method according to claim 1, wherein
a virtual measurement value for a first pair of source position (s) and detection position (s) is calculated from a plurality of measurement values for other pairs of source position and detection position, the arrangement of source position and detection position of the other pairs being adjacent to that of the first pair, and
a virtual measurement value corresponding to the reversed arrangement of source position (s) and detection position (d) with respect to the first pair is calculated from a plurality of measurement values for different pairs of source position and detection position, the arrangement of source position and detection position of the different pairs being adjacent to the reversed arrangement of source position and detection position of the first pair.

5. Method according to claim 1, wherein the information is provided as a graphical representation.

6. Method according to claim 1, wherein deterioration of measurement quality is automatically detected.

7. Method according to claim 1, wherein information is provided about whether motion of the medium (1) has occurred during image acquisition by exploiting the signal symmetry.

8. Method according to claim 1, wherein information is provided about whether at least one source position or detection position malfunctions by exploiting the signal symmetry.

9. Device for imaging the interior of media, comprising:
a receiving volume for receiving a medium to be examined;
at least one light source arranged to subsequently irradiate the receiving volume with light from a plurality of different source positions (s);
at least one detector arranged to detect light emanating from the receiving volume in a plurality of different detection positions (d) for each source position (s) for image acquisition; and
a processing unit adapted to provide information about whether the measurement quality is deteriorated by exploiting signal symmetry under reversal of the light path.

10. Device according to claim 9, wherein the plurality of different source positions (s) and the plurality of different detection positions (d) are distributed at a boundary of the receiving volume.

11. Device according to claim 9, wherein the source positions (s) and detection positions (d) are alternately distributed surrounding the receiving volume.

12. Device according to claim 9, wherein the boundary of the receiving volume is formed by a receiving portion (2) adapted to be filled with a scattering medium (5) for filling a space between the receiving portion (2) and the medium (1).

13. Device according to claim 9, wherein the receiving volume is formed by a pair of plates for holding the medium (1) in a compressed condition during data acquisition.

14. Device according to claim 9, wherein the processing unit is adapted to provide information about whether motion of the medium has occurred during image acquisition by exploiting the signal symmetry or the processing unit is adapted to provide information about whether at least one source position or detection position malfunctions by exploiting the signal symmetry.

15. Device according to claim 9, wherein the device is a medical image acquisition device.
